(19) United States
(12) Patent Application Publication
(10) Pub. No.: US 2025/0111420 A1
(43) Pub. Date: Apr. 3, 2025

(54) SEARCH DEVICE, SEARCHING METHOD, AND RECORDING MEDIUM

(71) Applicant: Rakuten Group, Inc., Tokyo (JP)

(72) Inventor: Shizuka ENDO, Tokyo (JP)

(73) Assignee: Rakuten Group, Inc., Tokyo (JP)

(21) Appl. No.: 18/898,867

(22) Filed: Sep. 27, 2024

(30) Foreign Application Priority Data
Sep. 28, 2023 (JP) 2023-168849

(51) Int. Cl. G06Q 30/0601; G06F 16/9532; G06Q 10/02

(52) U.S. Cl. CPC G06Q 30/0627; G06F 16/9532; G06Q 10/02

(57) ABSTRACT

A search device acquires a search string, and determines whether the acquired search string contains a tag defined in advance. When determining that the search string contains the tag, the search device deletes the tag from the search string, and sets the tag as a search index. On the basis of the set search index and the remaining character string made by deleting the tag from the search string, the search device generates search information for searching targeted information, and acquires a search result based on the generated search information.

### CROSS-REFERENCE TO RELATED APPLICATIONS

This application claims the benefit of Japanese Patent Application No. 2023-168849, filed on Sep. 28, 2023, the entire disclosure of which is incorporated by reference herein.

### FIELD OF THE INVENTION

This application relates to a search device, a searching method, and a recording medium.

### BACKGROUND OF THE INVENTION

Some reservation websites for accommodation facilities have been known that allow a user to enter a keyword indicating a condition of a preferable facility and to search via the Internet for a facility desired by the user. The user who performs searching by entering a character string, however, cannot always acquire a search result that accords with the user's expectation. This situation requires a technique for improving the accuracy of searching. In order to satisfy such a requirement, Unexamined Japanese Patent Application Publication No. 2021-96631 discloses a search system that uses a tag as a search index, for example.

### SUMMARY OF THE INVENTION

Even in this search system, users do not always succeed to select an appropriate tag, and often perform searching just by entering a character string. The search system is not satisfactory in terms of improvement of the accuracy of searching.

An objective of the present disclosure, which has been accomplished as a solution to the above problem, is to provide a search device, a searching method, and a recording medium that can improve the accuracy of searching.

A search device according to a first aspect of the present disclosure includes one or more processors. Each of the processors acquires a search string, and determines whether the acquired search string contains a tag defined in advance. When determining that the search string contains the tag, the processor deletes the tag from the search string, and sets the tag as a search index. The processor generates, based on the set search index and a remaining character string made by deleting the tag from the search string, search information for searching targeted information. The processor acquires a search result based on the generated search information.

The present disclosure can provide a search device, a searching method, and a recording medium that can improve the accuracy of searching.

### BRIEF DESCRIPTION OF DRAWINGS

A more complete understanding of this application can be obtained when the following detailed description is considered in conjunction with the following drawings, in which:

FIG. 1 illustrates a relationship among information terminals and a server;

FIG. 2 is a block diagram illustrating an exemplary information terminal;

FIG. 3 is an explanatory diagram illustrating exemplary tag information;

FIG. 4 is a flowchart illustrating an exemplary process of an entire system;

FIG. 5 is an explanatory diagram illustrating an exemplary screen of the information terminal;

FIG. 6 is another explanatory diagram illustrating the exemplary screen of the information terminal;

FIG. 7 is another explanatory diagram illustrating the exemplary screen of the information terminal;

FIG. 8 is another explanatory diagram illustrating the exemplary screen of the information terminal;

FIG. 9 is an explanatory diagram illustrating a modification of the exemplary screen of the information terminal;

FIG. 10 is an explanatory diagram illustrating another modification of the exemplary screen of the information terminal;

FIG. 11 is an explanatory diagram illustrating another modification of the exemplary screen of the information terminal; and

FIG. 12 is a flowchart illustrating a modification of the exemplary process of the entire system.

### DETAILED DESCRIPTION OF THE INVENTION

### Entire Configuration

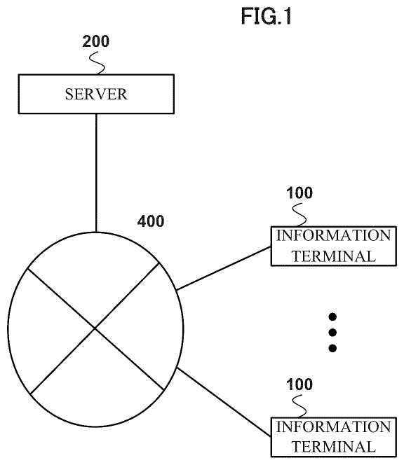

A search device, a searching method, and a program according to an embodiment of the present disclosure are described in detail below with reference to the accompanying drawings. In these drawings, the components identical or corresponding to each other are provided with the same reference symbol. As illustrated in FIG. 1, information terminals 100 according to the embodiment of the present disclosure are each connected to a server 200 via a computer communication network 400, such as the Internet, such that the information terminal 100 can communicate with the server 200. In this embodiment, the information terminal 100 serves as a search device. Although the following description of the embodiment focuses on an example of search for accommodation facilities desired by a user, the embodiment can also be applied to search for products on sale and search for financial products, other than search for accommodation facilities.

The information terminal 100 is a so-called computer, such as smartphone, tablet, or personal computer (PC), owned by the user. The information terminal 100 is capable of interactive communication with the server 200 via the computer communication network 400. Specifically, the information terminal 100 receives input of information on an accommodation facility desired by the user, and acquires, from the server 200, a search result based on the input information.

The server 200 has a function of providing tag information, a function of retrieving a search result based on search information, and a function of providing the search result to the information terminal 100, in response to a request from the information terminal 100.

### Functional Configuration of the Information Terminal

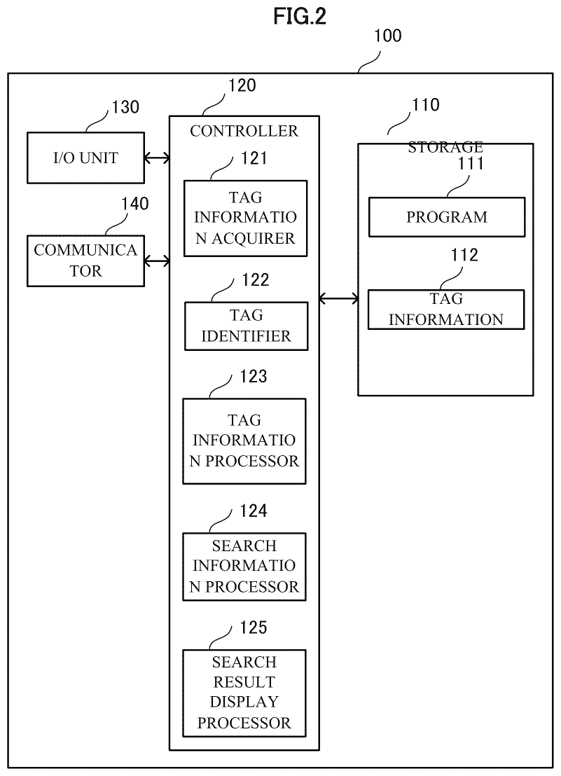

The following descries a configuration of the information terminal 100 with reference to FIG. 2.

As illustrated in FIG. 2, the information terminal 100 includes a storage 110, a controller 120, an input/output (I/O) unit 130, a communicator 140, and system buses (not illustrated) that connect the components with each other.

The storage 110 includes a read only memory (ROM) and a random access memory (RAM), for example. The ROM stores a program 111 to be executed by a central processing unit (CPU) of the controller 120, various types of data (not illustrated) required in advance of execution of the program 111, and tag information 112.

The program 111 is designed to provide a content described below, and is preliminarily stored in the storage 110.

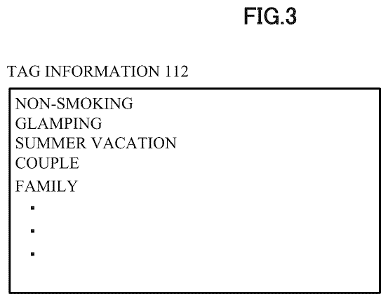

The tag information 112 indicates a list of tags (refer to FIG. 3). The tags correspond to information generated on the basis of hot keywords. For example, each of the tags contains a character string. The tag may correspond to a certain single word, or a series of multiple words. The tag corresponding to a series of multiple words is generated so as to encompass variations in representation, variations in language, synonyms, and a common concept, for example. The tag may also be a sentence, other than words. The tag may also be expressed by means of a concept (so-called ontology) for linking humans and computers together, for example. The tag information 112 is transmitted from the server 200 in response to a request from the information terminal 100, and then stored into the storage 110.

The controller 120 includes the CPU and an application specific integrated circuit (ASIC), for example. The controller 120 operates in accordance with the program 111 stored in the storage 110, and executes processes in accordance with the program 111. The controller 120 includes, as principal functional components achieved by the program 111 stored in the storage 110, a tag information acquirer 121, a tag identifier 122, a tag information processor 123, a search information processor 124, and a search result display processor 125.

The tag information acquirer 121 is a functional component that acquires the tag information 112 from the server 200. Specifically, the tag information acquirer 121 transmits, to the server 200, a tag information request for requesting transmission of the tag information 112, and thus acquires the tag information 112 from the server 200. The acquired tag information 112 is stored into the storage 110.

The tag identifier 122 is a functional component that determines whether the character string input by the user contains any of the tags indicated by the tag information 112. Specifically, the tag identifier 122 determines whether the search string entered into the entry field via the I/O unit 130 contains a character string identical to any of the tags indicated by the tag information 112. Although the description of the embodiment focuses on an example in which the tag identifier 122 determines whether the search string entered into the entry field contains the character string identical to the tag, the tag identifier 122 may also determine whether the search string contains a character string similar to any of the tags indicated by the tag information 112, for example. In this case, the tag identifier 122 calculates a degree of similarity between the tag and the character string contained in the search string, and determines the character string to be similar to the tag when the calculated degree is equal to or higher than a predetermined reference value. That is, the tag identifier 122 deems the search string containing a character string similar to the tag to contain the tag.

The tag information processor 123 is a functional component that deletes the tag contained in the search string input by the user from the search string, and sets the deleted tag as a search index. Specifically, when the tag identifier 122 determines the search string to contain the tag, the tag information processor 123 deletes the tag from the search string and sets the deleted tag as a search index.

The search information processor 124 is a functional component that generates search information and requests the server 200 to execute searching. Specifically, the search information processor 124 transmits search information, which contains the search index set by the tag information processor 123 and the search string after deletion of the tag, to the server 200, and thus requests the server 200 to execute searching.

The search result display processor 125 is a functional component that displays a search result transmitted from the server 200. Specifically, the search result display processor 125 receives, from the server 200, a search result of searching executed by the server 200 in response to the search request, and displays the search result to the user via the I/O unit 130.

The I/O unit 130 includes a keyboard, a mouse, a camera, a microphone, a liquid crystal display (LCD), or an organic electroluminescence (EL) display, for example. The I/O unit 130 inputs and outputs various types of data.

The communicator 140 allows the information terminal 100 to communicate with other information terminals, such as the server 200, via the computer communication network 400. The above-described components constitute the information terminal 100.

### Operations

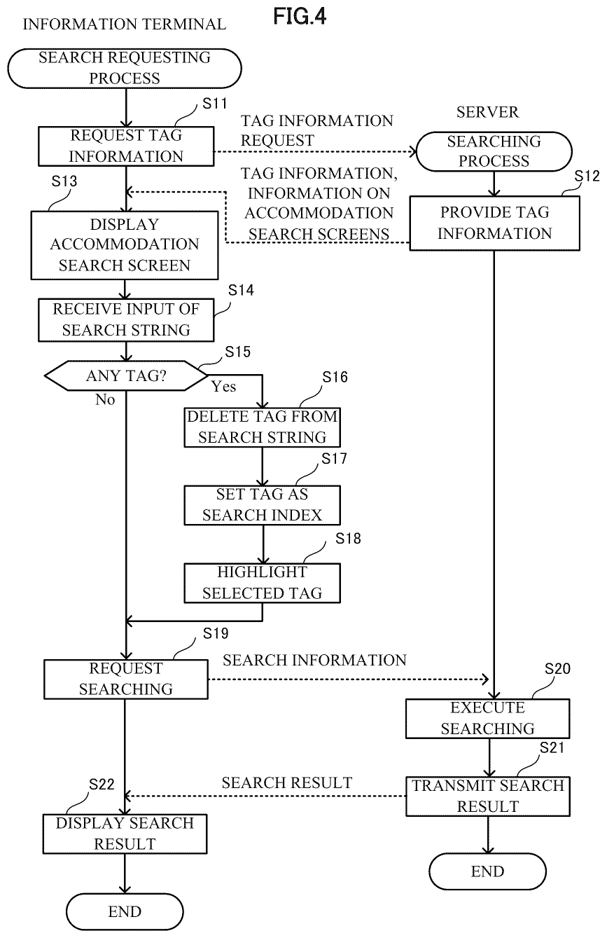

The following describes operations of the information terminal 100 and the server 200 with reference to FIGS. 4 to 8. FIG. 4 is a flowchart illustrating an exemplary process of the entire system, which involves a search requesting process in the information terminal 100 and a searching process in the server 200. The following description of the embodiment focuses on an example in which accommodation facilities are searched for by entering a search string “near a mall, non-smoking”. The tag information 112 is assumed to indicate the tags illustrated in FIG. 3.

First, the user manipulates the information terminal 100, and thus initiates the search requesting process illustrated in FIG. 4. Specifically, the user performs a manipulation for activating the application on the information terminal 100, and thus initiates the search requesting process. At the start of the search requesting process, the information terminal 100 requests the server 200 to transmit the tag information 112 (Step S11). Specifically, the controller 120 transmits a tag information request to the server 200 by means of the function of the tag information acquirer 121, in Step S11. The controller 120 thus acquires the tag information 112 from the server 200. The acquired tag information 112 is stored into the storage 110.

The server 200, when receiving the tag information request from the information terminal 100, initiates the searching process. At the start of the searching process, the server 200 transmits the tag information 112, which is preliminarily stored in the storage 110, to the information terminal 100 (Step S12). The information terminal 100 thus acquires the tag information 112. That is, the information terminal 100 acquires the tag information 112 by means of the function of the tag information acquirer 121. The acquired tag information 112 is stored into the storage 110. The server 200 also transmits information on accommodation search screens corresponding to search pages, as well as the tag information 112. The tag information 112 contains multiple keywords preliminarily defined by the administrator of the server 200 and is updated every day through addition of keywords, such as frequently searched keywords and seasonal keywords, on the basis of a search history. The content of the tag information 112 can be arbitrarily varied.

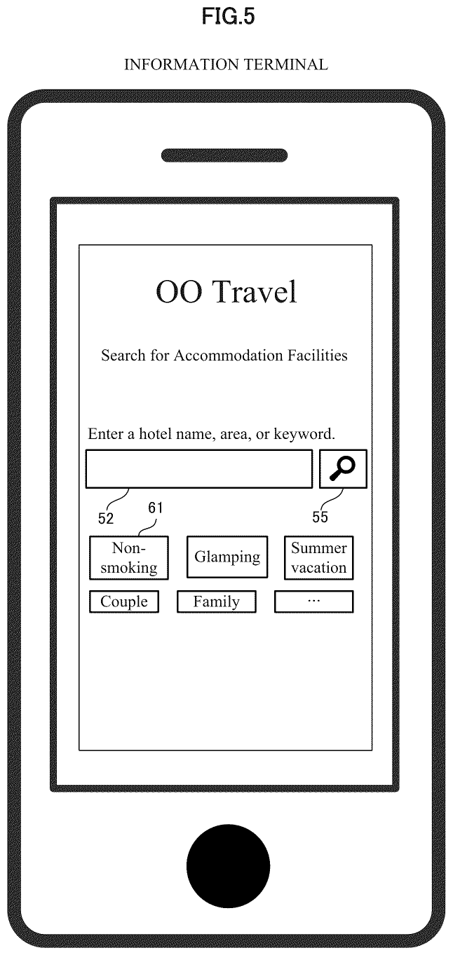

The information terminal 100 after acquiring the tag information 112 displays an accommodation search screen that contains an entry field and other items (Step S13). Specifically, in Step S13, the controller 120 displays, on the I/O unit 130, an accommodation search screen that contains an entry field 52, a search button 55, and tags 61 for search of accommodation facilities, for example, as illustrated in FIG. 5. This accommodation search screen allows the user to search for accommodation facilities. The accommodation search screen displayed in Step S13 contains the tags 61 identical to the tags indicated by the tag information 112 received from the server 200.

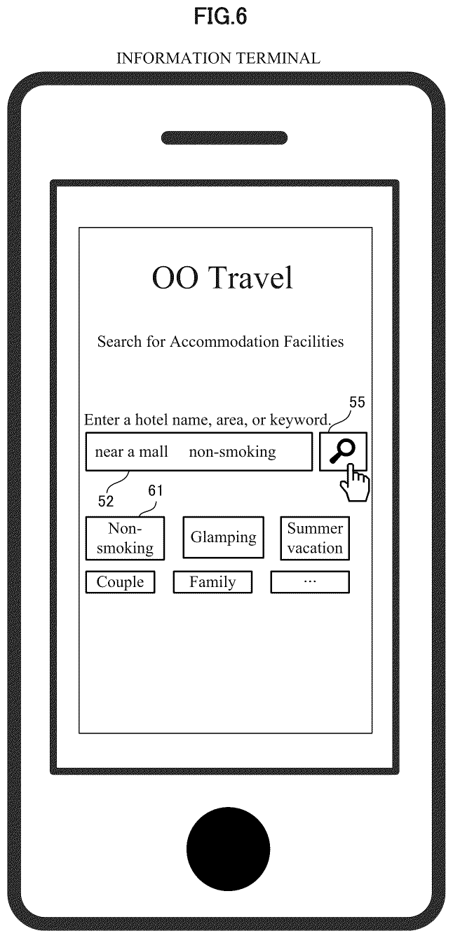

After Step S13, the information terminal 100 receives input of a search string in accordance with a manipulation performed by the user (Step S14). Specifically, in Step S14, the user performs a manipulation on the I/O unit 130, enters a search string “near a mall, non-smoking” into the entry field 52 as illustrated in FIG. 6, and then taps the search button 55.

After entry of a search string and tapping of the search button 55 in Step S14, the controller 120 determines whether the search string contains a tag by means of the function of the tag identifier 122 (Step S15). Specifically, in Step S15, the tag identifier 122 determines whether the search string input in Step S14 contains the character string identical to any of the tags indicated by the tag information 112 received from the server 200. In this example, the tag identifier 122 determines the search string to contain the character string identical to the tag, because the character string “non-smoking” contained in the search string is identical to the tag “non-smoking” contained in the tag information 112.

When determining that the search string contains the character string identical to the tag in Step S15 (Step S15; Yes), the controller 120 deletes the tag contained in the search string input by the user from the search string, by means of the function of the tag information processor 123 (Step S16). In this example, the character string “non-smoking” is deleted from the search string “near a mall, non-smoking” in Step S16.

After Step S16, the controller 120 sets the tag deleted in Step S16 as a search index, by means of the function of the tag information processor 123 (Step S17).

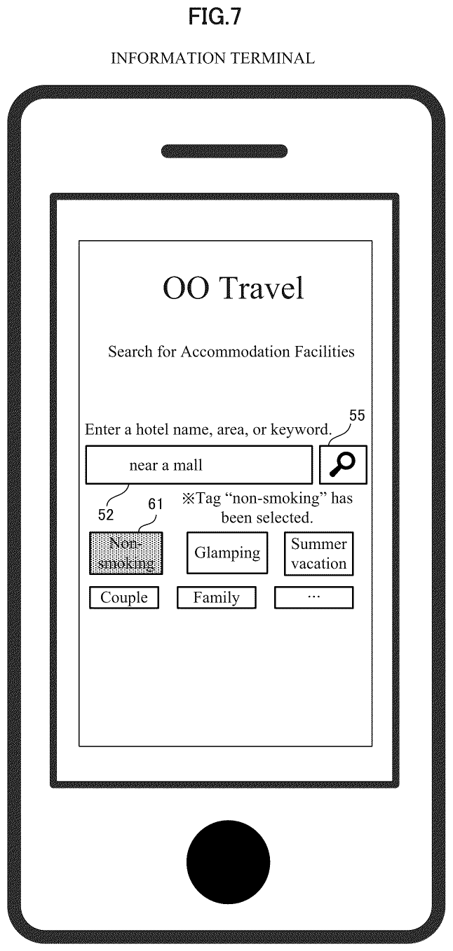

After Step S17, the controller 120 highlights the selected tag so as to allow the user to visually recognize completion of selection of the tag set as a search index in Step S17 (Step S18). Specifically, in Step S18, the tag information processor 123 highlights the selected tag “non-smoking” so as to be visually recognizable, and displays a message indicating completion of selection of the tag “non-smoking”, as illustrated in FIG. 7.

Referring back to FIG. 4, after Step S18, or when the search string is determined to contain no tag in Step S15 (Step S15; No), the search information processor 124 requests searching (Step S19). Specifically, in Step S19, when any tag is contained in the search string, the search information processor 124 transmits, to the server 200, search information containing the search index set in Step S17 and the search string from which the tag is deleted in Step S16, and thus requests searching. In contrast, when no tag is contained in the search string, the search information processor 124 transmits search information containing the original search string input in Step S14 to the server 200, and thus requests searching.

The server 200, when receiving the search information from the information terminal 100, executes searching (Step S20). Specifically, in Step S20, the server 200 searches the accommodation facilities that belong to the search index contained in the search information, for an accommodation facility that accords with the search string. In this example, the server 200 searches the accommodation facilities that belong to the search index “non-smoking”, for an accommodation facility containing a character string “near a mall”. More specifically, the server 200 searches for, as the accommodation facility that accords with the search string, an accommodation facility about which a review or introduction contains a character string identical to or similar to the character string “near a mall”.

After Step S20, the server 200 transmits a search result to the information terminal 100, and then terminates the searching process.

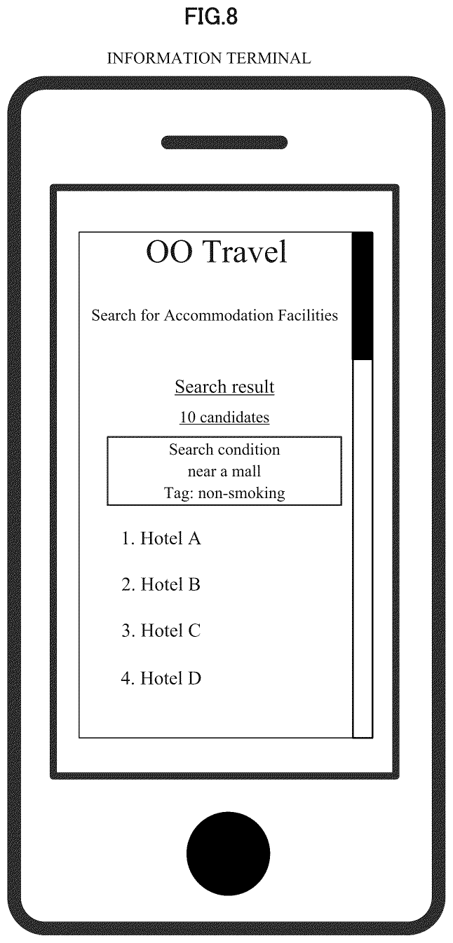

The information terminal 100, when receiving the search result, displays the received search result via the I/O unit 130, by means of the search result display processor 125 of the controller 120 (Step S22), and then terminates the search requesting process. Specifically, in Step S22, the search result display processor 125 causes the screen to display the search result in association with a search condition, as illustrated in FIG. 8. The search result contains links to the individual websites of the retrieved accommodation facilities. For example, tapping of the link “1. Hotel A” illustrated in FIG. 8 causes the screen to jump to a website for reservation of Hotel A. This configuration can certainly retrieve a “non-smoking” accommodation facility.

The information terminal 100 and the server 200 operate as described above. In an existing reservation website, for example, an accommodation facility may be provided with a review containing a sentence “This is not a non-smoking facility.” The reviewed accommodation facility, which is actually a cigar-friendly facility, may be unintentionally retrieved as a search result of the searching based on only the entry field containing the character string “near a mall, non-smoking” as in this embodiment. In addition, the user does not always voluntarily select the tag “non-smoking”. In order to solve these problems, this embodiment is characterized by automatic deletion of the character string corresponding to the tag from the search string and selection of the tag even in the case of the searching based on only the entry field. This configuration can retrieve an accommodation facility desired by the user and improve the accuracy of searching.

In Step S18, the information terminal 100 in this embodiment highlights the selected tag “non-smoking” so as to be visually recognizable, and displays a message indicating completion of selection of the tag “non-smoking”, as illustrated in FIG. 7, by means of the function of the tag information processor 123. The user can thus visually recognize that a part of the search string is automatically set as a tag. The user is therefore less likely to find it strange that the search string input by the user is automatically deleted.

### Modifications

The above-described embodiment of the present disclosure is a mere example and may be modified and developed in various manners. For example, the information terminal 100 according to the above-described embodiment does not necessarily have all of the above-illustrated technical features, and may include some of the components in the above-described embodiment so as to solve at least one problem in existing techniques. At least some of the modifications described below may be combined with each other.

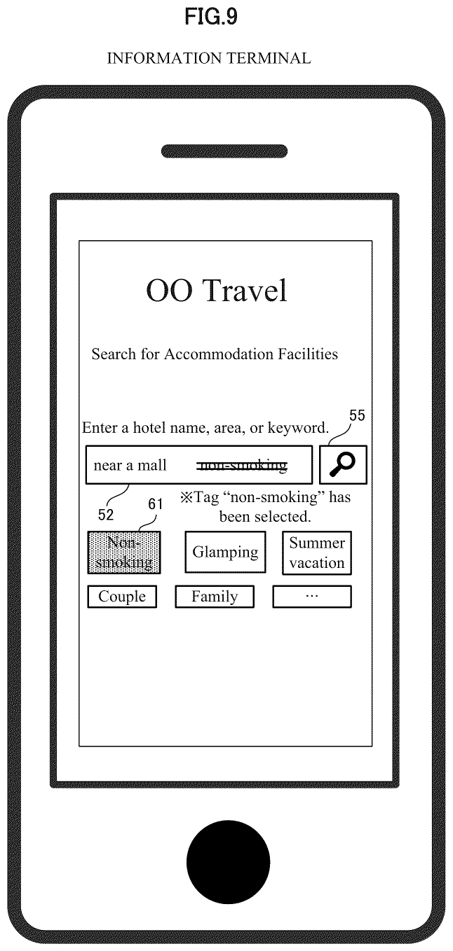

Although Step S16 illustrated in FIG. 4 involves complete deletion of the tag contained in the search string input by the user from the search string as illustrated in FIG. 7 in the above-described embodiment, this configuration is a mere example. For example, the tag contained in the search string may be deleted with a strikethrough, as illustrated in FIG. 9. Although the search string is deleted with a double strikethrough in the illustrated example, the search string may also be deleted with a single strikethrough. The user can therefore visually recognize deletion of the search string more obviously, and less likely to find it strange that the search string is automatically deleted.

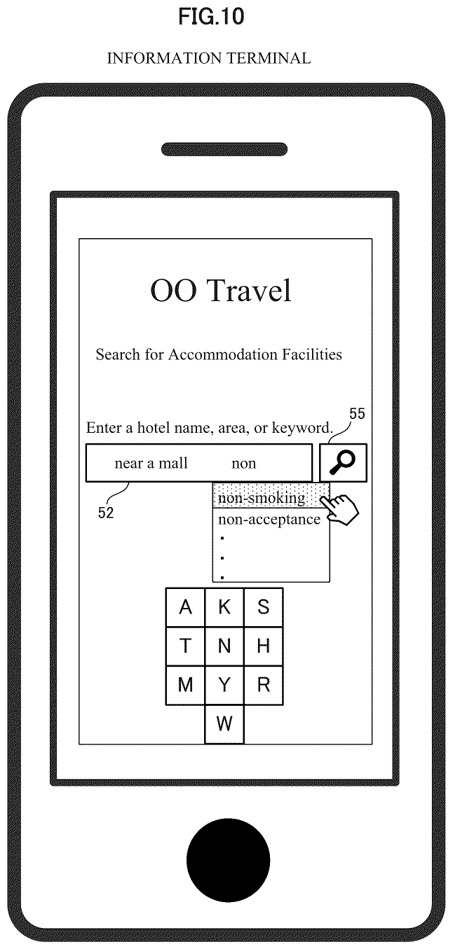

Although Step S14 illustrated in FIG. 4 involving entry of the search string “near a mall, non-smoking” into the entry field 52 and tapping of the search button 55 as illustrated in FIG. 6 is followed by Step S15 illustrated in FIG. 4 involving determination of whether the input search string contains the character string identical to any of the tags indicated by the tag information 112 in the above-described embodiment, this configuration is a mere example. Alternatively, while the user is entering a search string into the entry field 52 in Step S14 illustrated in FIG. 4, character strings expected to be entered may be displayed as candidate words, for example. In this case, when the user selects one of these candidate words, Step S15 is executed involving determination of whether the input search string contains the character string identical to any of the tags indicated by the tag information 112. Specifically, just after entry of a character string “near a mall, non”, candidate words, such as “non-smoking” and “non-acceptance”, may be displayed, as illustrated in FIG. 10. The selection of a candidate word “non-smoking” may lead to execution of Steps S15 to S18 illustrated in FIG. 4, followed by a jump to the display screen illustrated in FIG. 7. This modification can achieve setting of a tag during entry of a search string, and therefore simplify the user's manipulation.

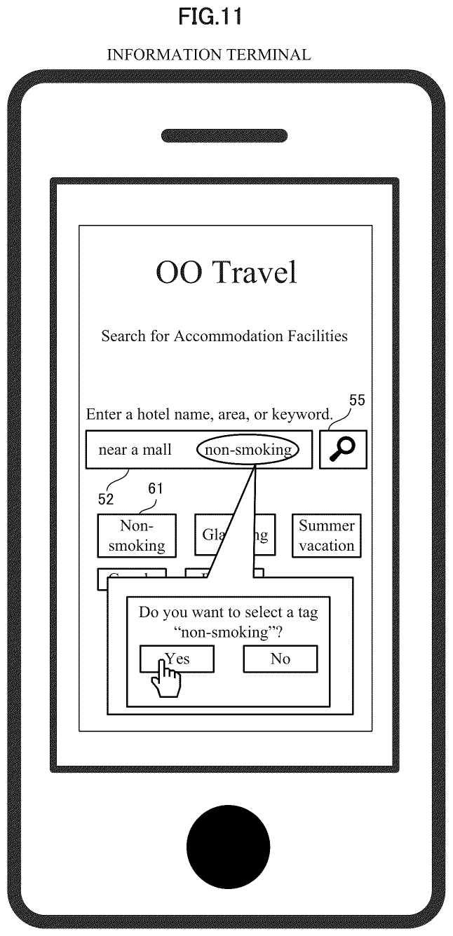

Although Step S14 illustrated in FIG. 4 involving entry of a search string and tapping of the search button 55 as illustrated in FIG. 6 is followed by Steps S15 to S18 illustrated in FIG. 4 involving automatic deletion of the tag contained in the search string and setting of the deleted tag as a search index in the above-described embodiment, this configuration is a mere example. For example, after Step S14 illustrated in FIG. 4 involving entry of a search string and tapping of the search button 55, when the search string is determined to contain the tag in Step S15 illustrated in FIG. 4, the screen may display options whether to select the tag contained in the search string and guide the user to select either one of the options, as illustrated in FIG. 11. When the user selects the option to select the tag, Steps S16 to S18 illustrated in FIG. 4 may be executed, followed by a jump to the display screen illustrated in FIG. 7. In contrast, when the user selects the option not to select the tag, Step S19 is executed using the original input search string as search information. This modification can avoid setting of a tag that is not accord with the user's intention, achieve searching suitable for the user's preference, and achieve setting of an appropriate tag.

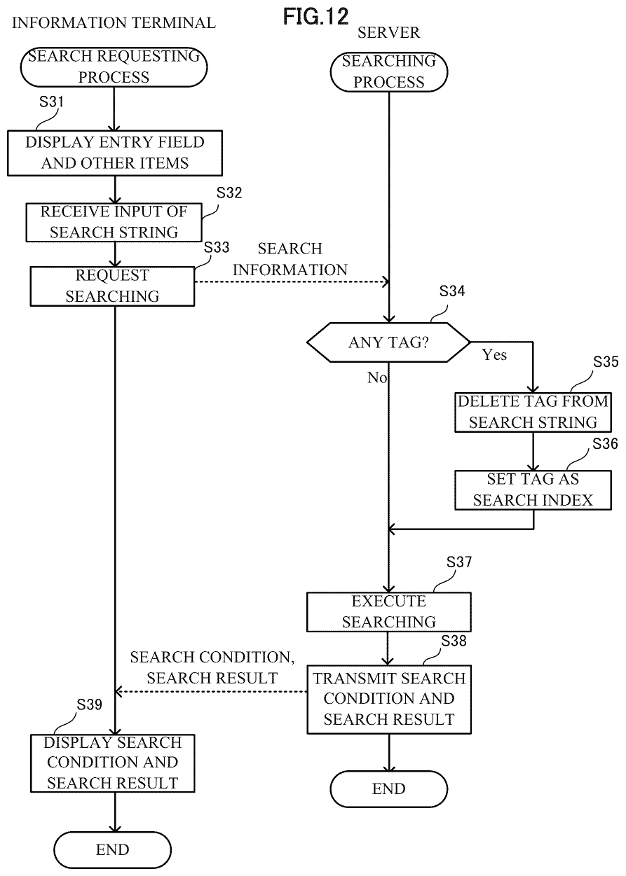

Although the information terminal 100 serves as a search device in the above-described embodiment, this configuration is a mere example. Alternatively, the server 200 may serve as a search device, for example. In this case, the server 200 includes at least the tag identifier 122, the tag information processor 123, and the search information processor 124, among the functional components illustrated in FIG. 2. Alternatively, the server 200 and the information terminal 100, which transmit and receive various types of information to and from each other, may share the functional components as appropriate. The following describes operations of the information terminal 100 and the server 200 that serves as a search device, with reference to FIG. 12.

First, the user manipulates the information terminal 100, and thus initiates the search requesting process illustrated in FIG. 12. Specifically, the user performs a manipulation for activating the application on the information terminal 100, and thus initiates the search requesting process. At the start of the search requesting process, the information terminal 100 displays an accommodation search screen that contains an entry field and other items, which is acquired from the server 200 (Step S31). Specifically, in Step S31, the controller 120 displays, on the I/O unit 130, an accommodation search screen that contains an entry field 52, a search button 55, and tags 61 for search of accommodation facilities, for example, as illustrated in FIG. 5.

After Step S31, the information terminal 100 receives input of a search string in accordance with a manipulation performed by the user, as in Step S14 illustrated in FIG. 4 (Step S32). The information terminal 100 transmits search information containing the search string input in Step S32 to the server 200, and thus requests searching (Step S33).

The server 200, when receiving the search information, determines whether the search information, that is, the search string contains a tag by means of the function of the tag identifier 122, as in Step S15 illustrated in FIG. 4 (Step S34).

When determining that the search string contains the character string identical to the tag in Step S34 (Step S34; Yes), the server 200 deletes the tag from the search string by means of the function of the tag information processor 123, as in Step S16 illustrated in FIG. 4 (Step S35).

After Step S35, the server 200 sets the deleted tag as a search index by means of the function of the tag information processor 123, as in Step S17 illustrated in FIG. 4 (Step S36), and executes searching (Step S37). In Step S37, the server 200 searches accommodation facilities that belong to the search index, for an accommodation facility that accords with the search string, as in Step S20 illustrated in FIG. 4.

After Step S37 illustrated in FIG. 12, the server 200 transmits a search condition and a search result to the information terminal 100 (Step S38), and terminates the searching process.

The information terminal 100, when receiving the search condition and the search result, displays the received search condition and search result via the I/O unit 130, as illustrated in FIG. 10, by means of the search result display processor 125 of the controller 120 (Step S39), and then terminates the search requesting process.

The information terminal 100 and the server 200 operate as described above, in the case of the server 200 serving as a search device according to the present disclosure. Since the server 200 is responsible for selection of a tag, the user, that is, the information terminal 100 is only required to entry a search string into the entry field and execute searching as in an existing system. This modification can improve the accuracy of searching without providing a feeling of strangeness to the user.

The functions of the information terminal 100 and the server 200 according to the above-described embodiment may be achieved by not only a dedicated device but an ordinal computer. For example, a program designed to cause a computer to execute any of the functions may be installed from a recording medium into a computer, so that the computer may serve as an information terminal 100 for executing the above-described processes. Alternatively, multiple computers may cooperate with each other and thus serve as a single information terminal 100 or server 200.

In the case where the above-described functions are achieved by sharing of an operating system (OS) and an application or by cooperation of the OS and the application, only the components other than the OS may be stored in a recording medium, for example.

The program may be distributed via a communication network while being superimposed on a carrier wave. For example, the program may be posted on a bulletin board system (BBS) on a communication network and may be distributed via the network. A computer may activate this program and execute the program under the control of the OS in the same manner as the other application programs, and thereby execute the above processes.

The following is a list of some modes of the present disclosure in the form of appendixes.

### Appendix 1

A search device, comprising:
one or more processors, wherein each of the processors
acquires a search string,
determines whether the acquired search string contains a tag defined in advance,
deletes the tag from the search string, and sets the tag as a search index, when determining that the search string contains the tag,
generates, based on the set search index and a remaining character string, search information for searching targeted information, the remaining character string being made by deleting the tag from the search string, and
acquires a search result based on the generated search information.

### Appendix 2

The search device according to appendix 1, wherein the processor
acquires the search string, and
deletes the tag from the search string at a timing of a searching manipulation performed by a user.

### Appendix 3

The search device according to appendix 1, wherein the processor deletes the tag from the search string while the user is entering the search string during acquisition of the search string.

### Appendix 4

The search device according to appendix 1, wherein when the processor determines that the search string contains the tag, the processor deletes the tag from the search string, and sets the tag as the search index, in response to a manipulation for setting of the tag performed by a user.

### Appendix 5

The search device according to any one of appendixes 1 to 4, wherein the search result is one or more pieces of the targeted information that correspond to the remaining character string, among pieces of the targeted information that belong to the search index contained in the search information.

### Appendix 6

The search device according to any one of appendixes 1 to 5, wherein when the processor deletes the tag from the search string, the processor displays information indicating completion of deletion of the tag so as to allow a user to visually recognize the information.

### Appendix 7

The search device according to any one of appendixes 1 to 7, wherein when the processor deletes the tag from the search string and sets the tag as the search index, the processor displays information indicating completion of setting of the tag as the search index so as to allow a user to visually recognize the information.

### Appendix 8

The search device according to appendix 3, wherein the processor
displays a complemented character string, while the user is entering the search string, the complemented character string serving as a complement for the search string being input by the user, and
deletes the tag from the search string at a timing of selection of the complemented character string.

### Appendix 9

A searching method executed by a search device, the method comprising:
acquiring a search string;
determining whether the acquired search string contains a tag defined in advance;
deleting the tag from the search string, and setting the tag as a search index, when determining that the search string contains the tag;
generating, based on the set search index and a remaining character string, search information for searching targeted information, the remaining character string being made by deleting the tag from the search string; and
acquiring a search result based on the generated search information.

### Appendix 10

A non-transitory computer-readable recording medium that stores a program configured to cause a computer to:
acquire a search string;
determine whether the acquired search string contains a tag defined in advance;
delete the tag from the search string, and set the tag as a search index, when determining that the search string contains the tag;
generate, based on the set search index and a remaining character string, search information for searching targeted information, the remaining character string being made by deleting the tag from the search string; and
acquire a search result based on the generated search information.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can provide a search device, a searching method, and a recording medium that can improve the accuracy of searching.

1. A search device, comprising:
one or more processors, wherein each of the processors
acquires a search string,
determines whether the acquired search string contains a tag defined in advance,
deletes the tag from the search string, and sets the tag as a search index, when determining that the search string contains the tag,
generates, based on the set search index and a remaining character string, search information for searching targeted information, the remaining character string being made by deleting the tag from the search string, and
acquires a search result based on the generated search information.

2. The search device according to claim 1, wherein the processor
acquires the search string, and
deletes the tag from the search string at a timing of a searching manipulation performed by a user.

3. The search device according to claim 1, wherein the processor deletes the tag from the search string while the user is entering the search string during acquisition of the search string.

4. The search device according to claim 1, wherein when the processor determines that the search string contains the tag, the processor deletes the tag from the search string, and sets the tag as the search index, in response to a manipulation for setting of the tag performed by a user.

5. The search device according to claim 1, wherein the search result is one or more pieces of the targeted information that correspond to the remaining character string, among pieces of the targeted information that belong to the search index contained in the search information.

6. The search device according to claim 1, wherein when the processor deletes the tag from the search string, the processor displays information indicating completion of deletion of the tag so as to allow a user to visually recognize the information.

7. The search device according to claim 1, wherein when the processor deletes the tag from the search string and sets the tag as the search index, the processor displays information indicating completion of setting of the tag as the search index so as to allow a user to visually recognize the information.

8. The search device according to claim 3, wherein the processor
displays a complemented character string, while the user is entering the search string, the complemented character string serving as a complement for the search string being input by the user, and
deletes the tag from the search string at a timing of selection of the complemented character string.

9. A searching method executed by a search device, the method comprising:
acquiring a search string;
determining whether the acquired search string contains a tag defined in advance;
deleting the tag from the search string, and setting the tag as a search index, when determining that the search string contains the tag;
generating, based on the set search index and a remaining character string, search information for searching targeted information, the remaining character string being made by deleting the tag from the search string; and
acquiring a search result based on the generated search information.

10. A non-transitory computer-readable recording medium that stores a program configured to cause a computer to:
acquire a search string;
determine whether the acquired search string contains a tag defined in advance;
delete the tag from the search string, and set the tag as a search index, when determining that the search string contains the tag;
generate, based on the set search index and a remaining character string, search information for searching targeted information, the remaining character string being made by deleting the tag from the search string; and
acquire a search result based on the generated search information.
